(19) United States
(12) Patent Application Publication
(10) Pub. No.: US 2008/0265766 A1
(43) Pub. Date: Oct. 30, 2008

(54) Flat panel display device and method of fabricating the same

(76) Inventors: Mun-Ho Nam, Suwon-si (KR); Hyoung-Bin Park, Suwon-si (KR); Seung-Hyun Son, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/081,892

(22) Filed: Apr. 23, 2008

(30) Foreign Application Priority Data
Apr. 24, 2007 (KR) 10-2007-0040038

(51) Int. Cl. H01J 1/62

(52) U.S. Cl. 313/505

(57) ABSTRACT

A flat panel display device includes first and second substrates spaced apart and facing each other, a plurality of discharge cells between the first and second substrates, an excitation gas in the discharge cells, a plurality of first electrodes between the first and second substrates, a plurality of second electrodes between the first and second substrates, a third electrode on each of the plurality of first electrodes, and a photoluminescent layer in at least one discharge cell of the plurality of discharge cells, the photoluminescent layer including at least one opening therethrough.

### BACKGROUND OF THE INVENTION

1. Field of the Invention

Embodiments of the present invention relate to a flat panel display device and a method of fabricating the same. More particularly, embodiments of the present invention relate to a flat panel display device having increased brightness and light transmittance, and to a method of fabricating the same.

2. Description of the Related Art

A flat panel display device, e.g., a plasma display device, an electron emission device, a gas excitation emitting device, and so forth, may refer to a device displaying images on a flat screen and having superior display characteristics, e.g., high brightness and wide viewing angles. For example, a flat panel display device may be driven by applying voltage, i.e., direct or alternating, to electrodes between two substrates, so an excitation gas between the two substrates may be ionized to trigger excitation of photoluminescent layers between the two substrates. The exited photoluminescent layers may emit visible light to form images upon re-stabilization.

In particular, conventional photoluminescent layers may be applied in a discharge space between the two substrates to facilitate collision with particles of the ionized excitation gas. When the applied photoluminescent layers are thin, however, an amount of visible light generated therefrom may be low, so brightness may be reduced. When the photoluminescent layers are thick, however, particles of the ionized excitation gas colliding with the photoluminescent layers may remain on a surface of the photoluminescent layers. Particles of the ionized excitation gas on the surface of the photoluminescent layers may charge the photoluminescent layers, so light emission and brightness may be reduced. In addition, conventional ionization of the excitation gas may require a high level of energy, so driving voltage may be increased and light emission efficiency may be decreased.

### SUMMARY OF THE INVENTION

Embodiments of the present invention are therefore directed to a flat panel display device and a method of fabricating the same, which substantially overcome one or more of the disadvantages and shortcomings of the related art.

It is therefore a feature of an embodiment of the present invention to provide a flat panel display device with photoluminescent layers capable of increasing brightness and light transmittance in the flat panel display device.

It is therefore another feature of an embodiment of the present invention to provide a flat panel display device with reduced driving voltage and increased light emission efficiency.

It is yet another feature of an embodiment of the present invention to provide a method of fabricating a flat panel display device having one or more of the above features.

At least one of the above and other features and advantages of the present invention may be realized by providing flat panel display device includes first and second substrates spaced apart and facing each other, a plurality of discharge cells between the first and second substrates, an excitation gas in the discharge cells, a plurality of first electrodes between the first and second substrates, a plurality of second electrodes between the first and second substrates, a third electrode on each of the plurality of first electrodes, and a photoluminescent layer in at least one discharge cell of the plurality of discharge cells, the photoluminescent layer including at least one opening therethrough to expose at least a portion of at least one surface of the discharge cell.

The flat panel display device may further include a first electron accelerating layer between a first electrode and a respective third electrode, the first electron accelerating layer being adapted to emit a first electron beam into the discharge cells when voltages are applied to the first and third electrodes. An energy of the first electron beam may be higher than energy required to excite the excitation gas and lower than energy required to ionize the excitation gas. The first and second electrodes may be a cathode electrode and an anode electrode, respectively. The first electron acceleration layer may include oxidized porous silicon.

The photoluminescent layer may include a plurality of discrete segments. The discrete segments may have a matrix pattern. The discrete segments may be spaced apart to have the openings therebetween. Each segment may be square-shaped. The photoluminescent layer may be on one or more of the first substrate, the second substrate, and/or sidewalls of the discharge cell. The surface of the discharge cell may be a surface of the second electrode. The first and second electrodes may be on the first and second substrates, respectively, and the photoluminescent layers may be on the second electrodes, the plurality of openings through the photoluminescent layers exposing portions of the second electrodes. The second and third electrodes may have a mesh structure.

The flat panel display device may further include a fourth electrode on each of the plurality of second electrodes, a second electron accelerating layer between a second electrode and a respective fourth electrode, the second electron accelerating layer being adapted to emit a second electron beam into the discharge cell when voltages are applied to the second and fourth electrodes, and a first electron accelerating layer between a first electrode and a respective third electrode, the first electron accelerating layer being adapted to emit a first electron beam into the discharge cell when voltages are applied to the first and third electrodes. In addition, the flat panel display device may include barrier ribs between the first and second substrates, a plurality of address electrodes extending on the first substrate along a direction crossing the second and fourth electrodes, and a dielectric layer on the first substrate, the address electrodes being between the dielectric layer and the first substrate.

The first and second electrodes may be on the first and second substrates, respectively. Both the first and second electrodes may be on the first substrate. The photoluminescent layers may be directly on the second substrate. The first, second, third, and fourth electrodes may be perpendicular to planes of the first and second substrates. Each of the first and second electrodes may be in contact with both the first and second substrates.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a partial cross-sectional view of a flat panel display device according to an embodiment of the present invention;

FIG. 2 illustrates a cross-sectional view along line IV-IV of FIG. 1;

FIG. 3 illustrates a graph of Xe energy level in the flat panel display of FIG. 1;

FIGS. 4A-4D illustrate exemplary voltages applied to electrodes in the flat panel display device of FIG. 1;

FIG. 5 illustrates a partial cross-sectional view of a flat panel display device according to another embodiment of the present invention;

FIG. 6 illustrates a partial cross-sectional view of a flat panel display device according to another embodiment of the present invention;

FIGS. 7A-7B illustrate exemplary voltages applied to electrodes in the flat panel display device of FIG. 6;

FIG. 8 illustrates a partial cross-sectional view of a flat panel display device according to another embodiment of the present invention;

FIG. 9 illustrates a partial cross-sectional view of a flat panel display device according to another embodiment of the present invention; and

FIGS. 10A-10D illustrate cross-sectional views of stages in a method of fabricating photoluminescent layers for a flat panel display device according to an embodiment of the present invention.

### DETAILED DESCRIPTION OF THE INVENTION

Korean Patent Application No. 10-2007-0040038, filed on Apr. 24, 2007, in the Korean Intellectual Property Office, and entitled: “Flat Panel Display Device and Method of Fabricating the Same,” is incorporated by reference herein in its entirety.

Embodiments of the present invention will now be described more fully hereinafter with reference to the accompanying drawings, in which exemplary embodiments of the invention are illustrated. Aspects of the invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers, elements, and regions may be exaggerated for clarity of illustration. It will also be understood that when a layer or element is referred to as being “on” another layer, element, or substrate, it can be directly on the other layer, element, or substrate, or intervening layers and/or elements may also be present. In addition, it will also be understood that when a layer or element is referred to as being “between” two layers or elements, it can be the only layer or element between the two layers or elements, or one or more intervening layers and/or elements may also be present. Like reference numerals refer to the like elements throughout.

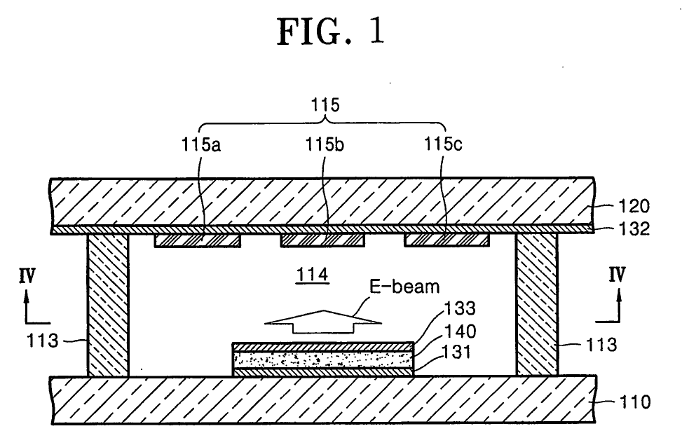

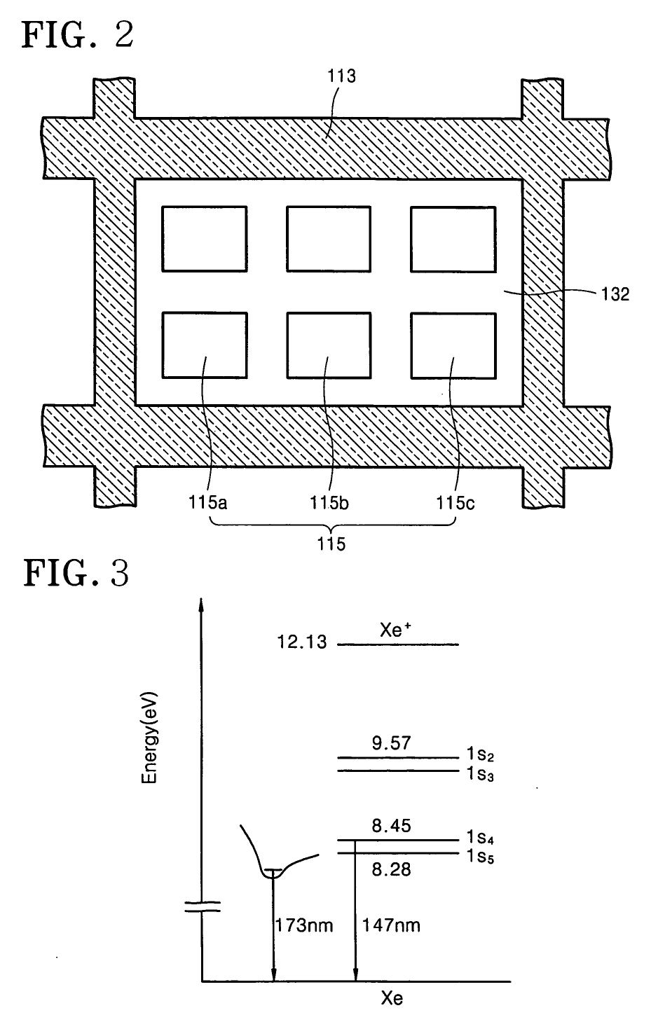

FIG. 1 illustrates a partial cross-sectional view of a flat panel display device according to an embodiment of the present invention, i.e., a cross-sectional view of a single discharge cell in the flat panel display device. FIG. 2 illustrates a cross-sectional view taken along line IV-IV of FIG. 1.

Referring to FIGS. 1-2, a flat panel display device may include a first substrate 110, a second substrate 120, and a plurality of barrier ribs 113 therebetween to define discharge cells. More specifically, as illustrated in FIGS. 1-2, a single discharge cell 114 of the flat panel display device may include a first electrode 131, a second electrode 132, a third electrode 133, a photoluminescent layer 115, and an electron acceleration layer 140. The flat panel display device may include a plurality of discharge cells 114.

The first substrate 110 and the second substrate 120 may face each other, and may be spaced apart from each other by a predetermined distance. The first substrate 110 and the second substrate 120 may be transparent. As illustrated in FIG. 1, the first and second substrates 110 and 120 may function as lower and upper substrates, respectively. Alternatively, the first substrate 110 may function as an upper substrate.

The barrier ribs 113 of the flat display device may be formed between the first and second substrates 110 and 120 to define a plurality of discharge cells 114 in a space between the first and second substrates 110 and 120. The barrier ribs 113 may prevent or substantially minimize electrical and optical cross-talk between the discharge cells 114. The barrier ribs 113 may be arranged in any suitable pattern. An excitation gas, e.g., a gas including xenon (Xe), may be filled in the discharge cells 114. The excitation gas, i.e., a discharge gas, refers to gas that may be excited by external energy, e.g., an electron beam, to generate ultraviolet (UV) light.

The first electrodes 131 of the flat panel display may be formed on the first substrate 110, e.g., on a surface facing the second substrate 120, along a first direction, so each of the discharge cells 114 may have one corresponding first electrode 131. The second electrodes 132 may be formed on the second substrate 120, e.g., on a surface facing the first substrate 110, along a second direction, e.g., a direction crossing the first direction, so each of the discharge cells 114 may have one corresponding second electrode 132. The third electrodes 133 may be formed on the first electrodes 131 and parallel thereto. The first, second, and third electrodes 131, 132, and 133 may be between the first and second substrates 110 and 120. The first and second electrodes 131 and 132 may be cathode and anode electrodes, respectively, and the third electrodes 133 may be grid electrodes. The second electrodes 132 may be formed of a transparent conductive material, e.g., indium tin oxide (ITO), so visible light may be transmitted therethrough toward the second substrate 120.

The photoluminescent layer 115 may be formed on the second electrodes 132 to face the discharge cells 114, as illustrated in FIG. 1, so the second electrodes 132 may be between the second substrate 120 and the photoluminescent layer 115. However, other configurations of the photoluminescent layer 115, e.g., the photoluminescent layer 115 may be on sidewalls of the barrier ribs 113 and/or on the first substrate 110, are within the scope of the present invention. The photoluminescent layer 115 may be excited by absorbing UV light generated by the excitation gas, and may emit visible light upon re-stabilization. Accordingly, the photoluminescent layer 115 may be formed of a material having high light emission efficiency at a wavelength of about 147 nm, i.e., a wavelength of UV light generated by the excitation gas. The photoluminescent layer 115 may include a phosphor layer (PL), a cathode luminescence (CL) layer, e.g., a sulfide phosphor material, a quantum dot (QD) layer, or a mixture thereof.

As illustrated in FIGS. 1-2, the photoluminescent layer 115 may include a plurality of photoluminescent segments. For example, the photoluminescent layer 115 may include a plurality of red (R), green (G), and blue (B) phosphor layers 115a, 115b, and 115c, respectively. The red phosphor layers 115a of the photoluminescent layer 115 may be formed of red light emitting phosphor, e.g., (Y,Gd)BO₃;Eu⁺³. The green phosphor layers 115b of the photoluminescent layer 115 may be formed of green light emitting phosphor, e.g., Zn₂SiO₄:Mn²⁺. The blue phosphor layers 115c of the photoluminescent layer 115 may be formed of blue light emitting phosphor, e.g., BaMgAl₁₀O₁₇:Eu²⁺, CaMgSi₂O₈:Eu²+, or a mixture thereof. The R, G, and B phosphor layers 115a, 115b, and 115c may be excited using a low voltage, so light emission efficiency of the flat panel display device may be increased.

The plurality of photoluminescent segments of the photoluminescent layer 115, e.g., the R, G, and B phosphor layers 115a, 115b, and 115c, may be spaced apart from each other on each second electrode 132, so portions of the second electrodes 132 may be exposed. For example, as illustrated in FIGS. 1-2, the plurality of R, G, and B phosphor layers 115a, 115b, and 115c may be spaced apart from each other to form a matrix pattern on the second electrode 132, so portions of the second electrode 132 may be exposed to the discharge cell 114. When the photoluminescent layer 115 is not a single continuous layer on the second electrodes 132, i.e., includes multiple R, G, and B phosphor layers 115a, 115b, and 115c spaced apart from each other, excited particles of the excitation gas may enter the second electrodes 132 through the spaces between the R, G, and B phosphor layers 115a, 115b, and 115c. Thus, accumulation of excited particles, e.g., charged electrons, on the surface of the photoluminescent layer 115 may be prevented or substantially minimized. Also, the spaces between the R, G, and B phosphor layers 115a, 115b, and 115c may facilitate visible light transmission through the photoluminescent layer 115 toward the second substrate 120, so brightness and light emission efficiency may be increased.

The plurality of photoluminescent segments of the photoluminescent layer 115, e.g., each of the R, G, and B phosphor layers 115a, 115b, and 115c, may have any suitable shape, e.g., a square, a rectangle, a circle, and so forth, and size, as determined with respect to a size of a unit pixel, electron transmittance, light emission efficiency, brightness, fabricating costs, difficulty of fabrication, and so forth. The plurality of photoluminescent segments may have substantially same dimensions, and a size of each single photoluminescent segment may be smaller than a size of a unit pixel. For example, if a dimension of a unit pixel is about 200 μm×700 μm, and the photoluminescent segments are square-shaped, a length of each side of each of the photoluminescent segments may be about 20 μm to about 100 μm. A size of the photoluminescent segments may be optimized, e.g., by experimental data, in order to provide both sufficient open area, i.e., spaces between the photoluminescent segments exposing the second electrodes 132, and sufficient photoluminescent material. When the size of the photoluminescent segments is too large, the open area may be too small to provide light transmittance and to minimize charge on the photoluminescent layer 115. When the size of the photoluminescent segments is too small, fabrication thereof may be complicated, so manufacturing costs thereof may be increased.

The electron acceleration layer 140 in each discharge cell 114 of the flat panel display device may be formed on the first electrode 131, i.e., each electron acceleration layer 140 may be between the first and third electrodes 131 and 133. The electron acceleration layer 140 may be formed of any material that can generate an electron beam by accelerating electrons, e.g., oxidized porous silicon. The oxidized porous silicon may include, e.g., oxidized porous polysilicon, oxidized porous amorphous silicon, and so forth.

The electron acceleration layers 140 may generate an electron beam (E-beam), and may transmit the generated E-beam into the discharge cells 114 through the third electrodes 133. More specifically, when a predetermined voltage is applied to the first and third electrodes 131 and 133, the electron acceleration layer 140 may accelerate electrons from the first electrodes 131 through the third electrodes 133 into the discharge cells 114. The accelerated electrons may excite the excitation gas in the discharge cells 114, so UV light may be generated during re-stabilization of the excitation gas. The UV light may excite the photoluminescent layer 115, so the photoluminescent layer 115 may emit visible light toward the second substrate 120 to display images.

The E-beams generated by the electron acceleration layers 140 may have a predetermined energy. In particular, the predetermined energy may be higher than energy required for exciting the excitation gas and lower than energy required for ionizing the excitation gas. Accordingly, an optimized voltage corresponding to the predetermined energy of the E-beams may be applied to the first and third electrodes 131 and 133.

For example, as illustrated in FIG. 3, energy of about 8.28 eV or higher may be required to excite Xe, i.e., provide sufficient energy to move an electron of Xe from a ground state to a higher energy state, while energy of about 12.13 eV or higher may be required to ionize Xe, i.e., provide sufficient energy to completely remove an electron of Xe to form a Xe ion. More specifically, energies of 8.28 eV, 8.45 eV, and 9.57 eV may be required to excite Xe to 1 S₅, 1 S₄, and 1 S₂ states, respectively. Excited Xe, i.e., Xe*, may collide with non-excited Xe to generate excimers Xe₂*. Excited Xe, i.e., Xe*, may generate UV light having a wavelength of about 147 nm, and the excimers Xe₂ may generate UV light having a wavelength of about 173 nm. Accordingly, the E-beams emitted into the discharge cells 114 by the electron acceleration layers 140 may require an energy level of about 8.28 eV or higher and lower than about 12.13 eV in order to excite the Xe gas. For example, the E-beam may have energy of about 8.28 eV to about 9.57 eV or energy of about 8.28 eV to about 8.45 eV.

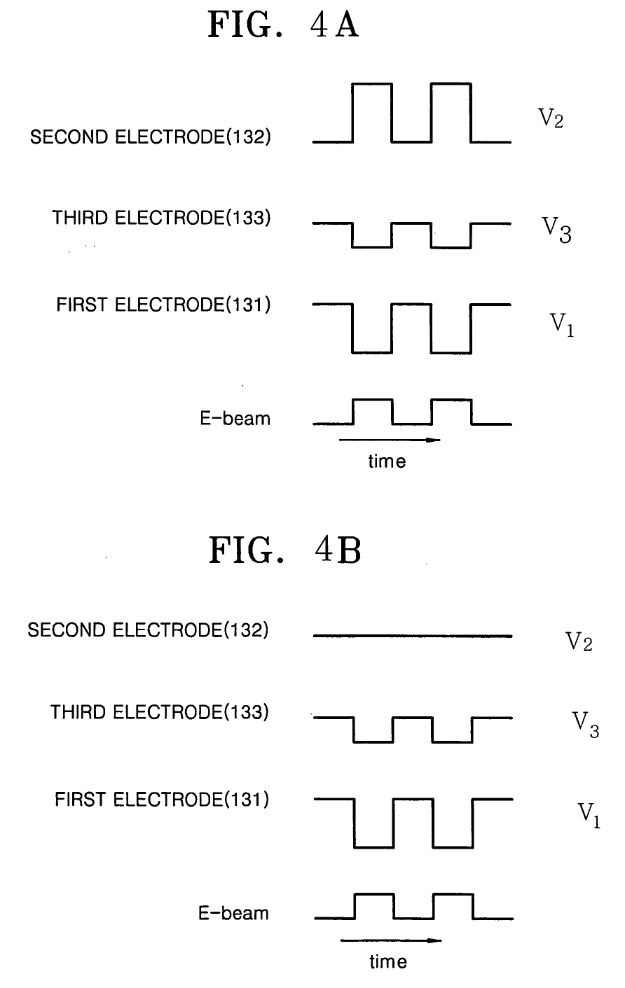

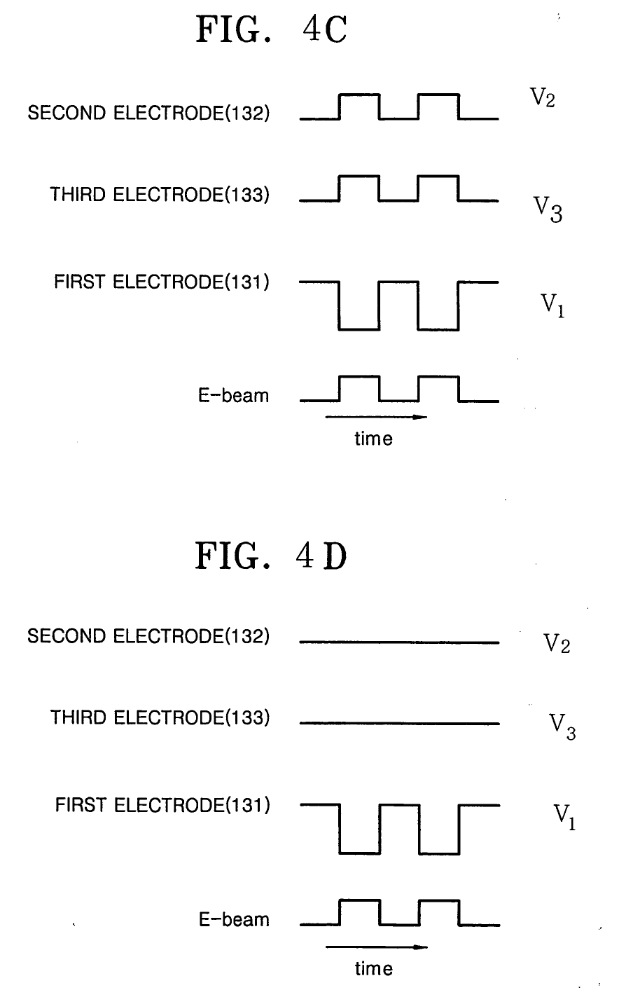

FIGS. 4A-4D illustrate types of voltages that can be applied to the electrodes of the flat panel display device of FIG. 1. Referring to FIG. 4A, voltages V₁, V₂, and V₃ may be respectively applied to the first, second, and third electrodes 131, 132, and 133, while the voltages may satisfy the condition V₁<V₃<V₂. Application of voltages V₁ and V₃ to the first and third electrodes 131 and 133, respectively, may trigger emission of the E-beams into the discharge cells 114 through the electron acceleration layers 140, and application of voltages V₂ and V₃ to the second and third electrodes 132 and 133, respectively, may facilitate acceleration of the E-beams toward the second electrodes 132. The E-beams in the discharge cells 114 may excite the excitation gas therein, and may be controlled by adjusting voltage V₂, i.e., voltage applied to the second electrodes 132. For example, voltage V₂ may be positive, as illustrated in FIG. 4A, or may be grounded, as illustrated in FIG. 4B, so electrons reaching the second electrode 132 may leak to the outside.

Referring to FIG. 4C, voltages V₁, V₂, and V₃ may be applied to the first, second, and third electrodes 131, 132, and 133, respectively, and may satisfy the condition V₁<V₃=V₂. Application of voltages V₁ and V₃ to the first and third electrodes 131 and 133, respectively, may trigger emission of E-beams into the discharge cells 114 through the electron acceleration layers 140 to excite the excitation gas. As illustrated in FIG. 4D, the second electrodes 132 and the third electrodes 133 may be grounded, so electrons reaching the second electrodes 132 may leak to the outside.

The flat panel display device may further include dielectric layers (not shown), e.g., on the second electrodes 132. Further, the flat panel display device may include a protective layer (not shown) formed of, e.g., magnesium oxide (MgO), to shield the dielectric layer from being damaged by charged particles and to reduce a discharge voltage by emitting secondary electrons. A plurality of address electrodes (not shown) may further be formed on one of the first and second substrates 210 and 220.

The flat panel display device according to embodiments of the present invention may be advantageous in providing photoluminescent layers 115 having a plurality of photoluminescent segments spaced apart from each other, i.e., discrete segments, so light transmittance may be increased through the photoluminescent layers 115. Further, the photoluminescent layers 115 may be excited using a low voltage, thereby increasing light emission efficiency of the flat panel display device. In addition, spaces between the photoluminescent segments of the photoluminescent layers 115 may decrease charge on the surface thereof, so brightness may be enhanced. Also, forming the photoluminescent layer 115 to have a plurality of discrete photoluminescent segments may be advantageous in fabricating a flat panel display device with a large screen. Additionally, control of the voltage applied to the electrodes may adjust the predetermined energy of the E-beams to be lower than ionization energy of the excitation gas, so driving voltage may be reduced and light emission efficiency may be increased.

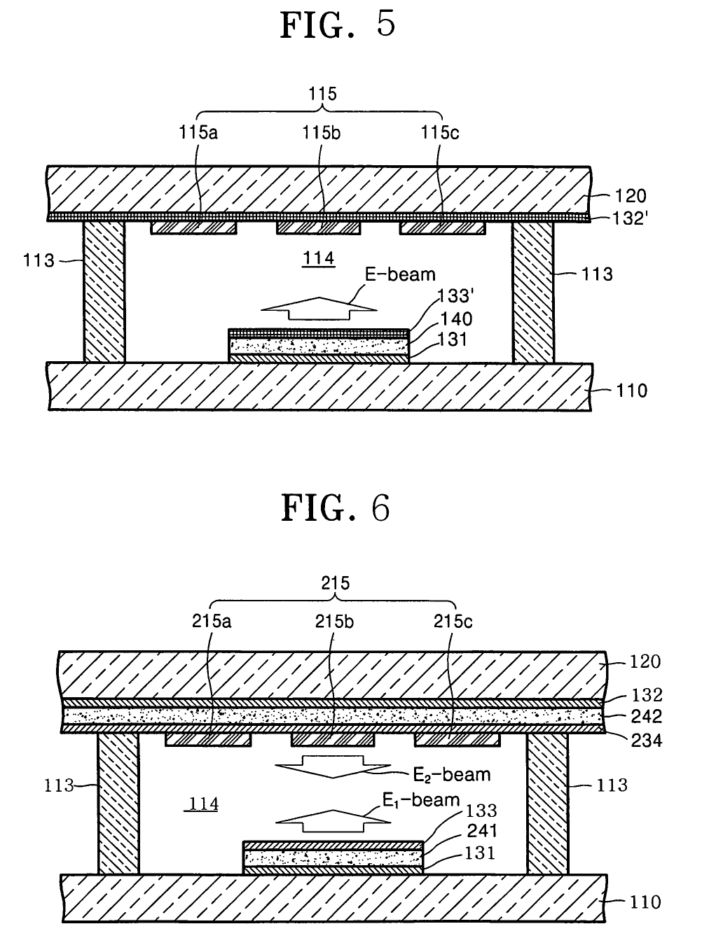

FIG. 5 illustrates a partial cross-sectional view of a flat panel display device according to another embodiment of the present invention. Referring to FIG. 5, a flat panel display device may be substantially similar to the flat panel display device described previously with reference to FIGS. 1-4D, with the exception of having second and third electrodes 132′ and 133′ with mesh structures, instead of the non-mesh second and third electrodes 132 and 133. More specifically, the second electrodes 132′ may include openings therein to facilitate transmission of visible light generated in the discharge cells 114 therethrough. The third electrodes 133′ may have openings therein to facilitate emission of electrons by the electron acceleration layers 140 therethrough toward the discharge cells 114.

FIG. 6 illustrates a partial cross-sectional view of a flat panel display device according to another embodiment of the present invention. Referring to FIG. 6, a flat panel display device may be substantially similar to the flat panel display device described previously with reference to FIGS. 1-4D, with the exception of having first and second electron acceleration layers 241 and 242 on the first and second electrodes 131 and 132, respectively. Third and fourth electrodes 133 and 234 may be respectively formed on the first and second electron acceleration layers 241 and 242.

The first and second electron acceleration layers 241 and 242 of the flat panel display device may be formed of any material that can generate an electron beam by accelerating electrons, e.g., oxidized porous silicon. Oxidized porous silicon may include, e.g., oxidized porous polysilicon, oxidized porous amorphous silicon, and so forth. The first electron acceleration layers 241 may be substantially similar to the electron acceleration layers 141 described previously with reference to FIGS. 1-2, and therefore, their detailed description will not be repeated. The second electron acceleration layers 242 may be substantially similar to the first electron acceleration layers 241, with the exception of their position. More specifically, the second electron acceleration layers 242 may be between the second and fourth electrodes 132 and 234. The fourth electrodes 234 may be formed of a transparent conductive material, e.g., ITO, to facilitate transmission of visible light therethrough toward the second substrate 120. The third and fourth electrodes 133 and 234 may have a mesh structure to facilitate electron passage therethrough, i.e., as described previously with reference to the third electrodes 133′ in FIG. 5.

When predetermined voltages are respectively applied to the first and third electrodes 131 and 133, the first electron acceleration layers 241 may emit first electron beams, i.e., E₁-beams, into the discharge cells 114 through the third electrodes 133 by accelerating electrons entering from the first electrodes 131. Similarly, when predetermined voltages are respectively applied to the second and fourth electrodes 132 and 234, the second electron acceleration layers 242 may emit second electron beams, i.e., E₂-beams, into the discharge cells 114 through the fourth electrode 234 by accelerating electrons entering from the second electrode 132. The E₁ and E₂ beams may be alternately emitted into the discharge cells 114 by applying an alternating current (AC) voltage between the first and second electrodes 131 and 132. Accordingly, the E₁ and E₂ beams may alternately excite the excitation gas to generate UV light. As described previously, each of the E₁ and E₂ beams may have a higher energy than energy required for exciting the excitation gas and lower energy than energy required for ionizing the excitation gas. More specifically, each. of the E₁ and E₂ beams may have energy of at least 8.28 eV and lower than about 12.13 eV to excite the excitation gas.

As illustrated in FIG. 6, each discharge cell 114 of the flat panel display device may include a photoluminescent layer 215. The photoluminescent layers 215 may be substantially similar to the photoluminescent layers 115 described previously with reference to FIGS. 1-4D, with the exception of being formed on the fourth electrodes 234. For example, R, G, and B phosphor layers 215a, 215b, and 215c of the photoluminescent layers 215 may be spaced apart from each other on the fourth electrodes 234 to expose portions of the fourth electrodes 234 to the discharge cells 114. Accordingly, electrons in the E₁-beam and the E₂-beam may pass through the spaces between the R, G, and B phosphor layers 215a, 215b, and 215c to enter the fourth and second electrodes 234 and 132. Due to the above configuration, charged particles on the surface of the photoluminescent layer 215 may be reduced, so transmittance of visible light therethrough may be increased, which in turn, may increase brightness and light emission efficiency. Additional advantages of the flat panel display device of FIG. 6 may be substantially similar to the advantages of the flat panel display of FIG. 1 described previously, and therefore will not be repeated.

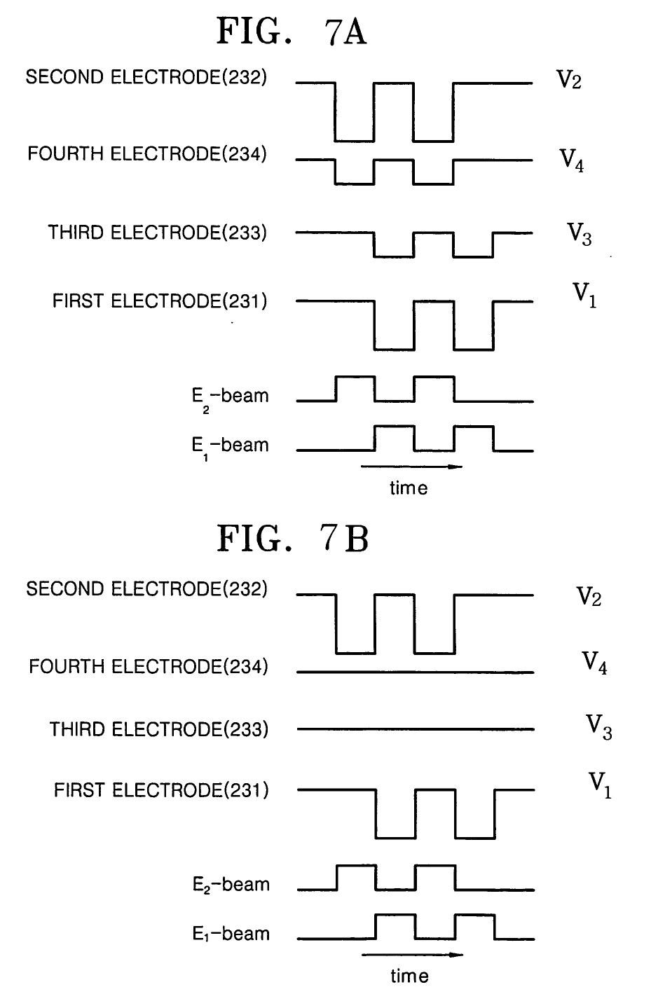

FIGS. 7A-7B illustrate voltages applied to electrodes in the flat panel display device of FIG. 6. Referring to FIG. 7A, voltages V₁, V₂, V₃, and V₄ may be respectively applied to the first electrodes 131, second electrodes 132, third electrodes 133, and fourth electrodes 234, while the voltages may satisfy the conditions V₁<V₃ and V₂<V₄. Application of voltages V₁ and V₃ to the first and third electrodes 131 and 133 may trigger emission of the E₁-beams into the discharge cells 114 through the first electron acceleration layers 241, and application of voltages V₂ and V₄ to the second and fourth electrodes 132 and 234 may trigger emission of the E₂-beams into the discharge cells 114 through the second electron acceleration layers 242. Since an AC voltage may be applied between the first electrodes 131 and the second electrodes 132, the E₁-beams and the E₂-beams may be alternately emitted into the discharge cells 114 to excite the excitation gas therein. As illustrated in FIG. 7B, the third and fourth electrodes 133 and 234 may be grounded.

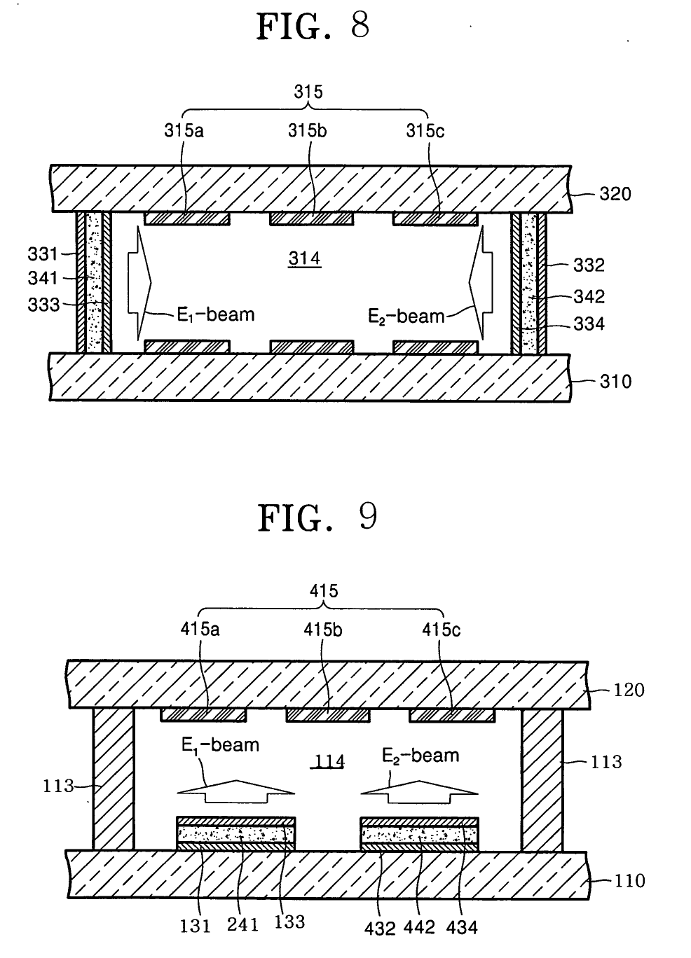

FIG. 8 illustrates a partial cross-sectional view of a flat panel display device according to another embodiment of the present invention. Referring to FIG. 8, a flat panel display device may include a first substrate 310 and a second substrate 320 spaced apart and facing each other, a plurality of discharge cells 314 between the first and second substrates 310 and 320, an excitation gas, e.g., a gas including Xe in the discharge cells 314, first, second, third, and fourth electrodes 331, 332, 333, and 334, first and second electron acceleration layers 341 and 342, and a photoluminescent layer 315 in each discharge cell 314. A plurality of address electrodes (not shown) may further be formed on the first substrate 310, e.g., on a surface facing the second substrate 320, and may be buried in a dielectric layer (not shown). The first and second substrates 310 and 320 may be substantially similar to the first and second substrate 110 and 120, respectively, of FIG. 1, and therefore, their detailed description will not be repeated.

The first, second, third, and fourth electrodes 331, 332, 333, and 334 may be formed in each of the discharge cells 314 between the first and second substrates 310 and 320. In particular, the first, second, third, and fourth electrodes 331, 332, 333, and 334 may be positioned perpendicularly to planes of the first and second substrates 310 and 320, so each of the first, second, third, and fourth electrodes 331, 332, 333, and 334 may be in contact with both the first and second substrates 310 and 320. The first and second electron acceleration layers 341 and 342 may be formed on sidewalls of the first and second electrodes 331 and 332, respectively, and the third and fourth electrodes 333 and 334 may be formed on the first and second electron acceleration layers 341 and 342, respectively. Accordingly, each discharge cell 314 may include one first acceleration layer 341 sandwiched between the first and third electrodes 331 and 333, and one second electron acceleration layer 342 sandwiched between the second and fourth electrodes 332 and 334. The third and fourth electrodes 333 and 334 may have mesh structures to facilitate electron acceleration therethrough. The first and second electron acceleration layers 341 and 342 may be formed of any material that can generate an electron beam by accelerating electrons, e.g., oxidized porous silicon. The oxidized porous silicon may include, e.g., oxidized porous polysilicon, oxidized porous amorphous silicon, and so forth.

The first and second electron acceleration layers 341 and 342 may be positioned at opposite sides of each discharge cell 314. As such, each structure of an electron acceleration layer sandwiched between two electrodes may contact the first and second substrates 310 and 320, and may function as a barrier between two adjacent discharge cells 314, i.e., define the discharge cells 314. Barrier ribs (not shown) may further be formed between the first and second substrates 310 and 320 to define the discharge cells 314.

Application of voltages to the first, second, third, and fourth electrodes 331, 332, 333, and 334 may cause emission of E₁ and E₂ beams into the discharge cells 314. Application of voltages and generation of E-beams in the flat panel display device of FIG. 8 may be substantially similar to application of voltages and generation of E-beams described previously with reference to FIGS. 6-7B, with the exception of a direction of the E-beams with respect to the first and second substrates 310 and 320. In particular, as illustrated in FIG. 8, directions of the E₁ and E₂ beams may be parallel to the planes of the first and second substrates 310 and 320.

The photoluminescent layer 315 may be substantially similar to the photoluminescent layers 115 and 215, with the exception of being formed on both the first and second substrates 310 and 320. Formation of the photoluminescent layer 315 on both the first and second substrates 310 and 320 may increase light emission efficiency and brightness. Additional advantages of the flat panel display device of FIG. 8 may be substantially similar to the advantages of the flat panel display of FIG. 1 described previously, and therefore, will not be repeated.

FIG. 9 illustrates a partial cross-sectional view of a flat panel display device according to another embodiment of the present invention. Referring to FIG. 9, a flat panel display device may be substantially similar to the flat panel display device described previously with reference to FIGS. 6-7B, with the exception of having a second electrode 433, a second electron acceleration layer 442, and a fourth electrode 434 on the first substrate 310. As such, two structures of an electron acceleration layer sandwiched between two electrodes may be formed on a single substrate, e.g., on the first substrate 110. Accordingly, a photoluminescent layer 415 of the flat panel display may be formed on the second substrate 120, e.g., directly on the second substrate 120.

Mores specifically, the first and second electrodes 131 and 432 may be formed on the first substrate 110 in an alternating pattern, so each discharge cell 114 may have a corresponding pair of first and second electrodes 131 and 432. The first and second electrodes 131 and 432 may extend along a substantially same direction. First and second electron acceleration layers 141 and 442 may be respectively formed on the first and second electrodes 431 and 432. Third and fourth electrodes 133 and 434 may be respectively formed on the first and second electron acceleration layers 141 and 442. The first and second electron acceleration layers 141 and 442 may be formed of any material that can generate an electron beam by accelerating electrons, e.g., oxidized porous silicon. The oxidized porous silicon may include, e.g., oxidized porous polysilicon, oxidized porous amorphous silicon, and so forth.

When voltages are applied to the first, second, third, and fourth electrodes 131, 432, 133, and 434, E₁ and E₂beams may be emitted into the discharge cells 114. Application of voltages and generation of E-beams in the flat panel display device of FIG. 9 may be substantially similar to application of voltages and generation of E-beams described previously with reference to FIGS. 6-7B, with the exception of a direction of the E-beams with respect to each other. In particular, as illustrated in FIG. 9, the E₁ and E₂ beams may be directed in a substantially same direction.

The photoluminescent layer 415 may be substantially similar to the photoluminescent layer 215, with the exception of being formed on the second substrate 120, e.g., directly on the second substrate 120. As such, spaces between photoluminescent segments of the photoluminescent layer 415 may expose portions of the second substrate 120 to the discharge cells 114. Accordingly, charged particles may pass through the photoluminescent layer 415 toward the second substrate 120, thereby minimizing charge on a surface of the photoluminescent layer 415. It is further noted that formation of the photoluminescent layer 415 on, e.g., sidewalls of the barrier ribs 113 and the first substrate 110, is within the scope of the present invention. Advantages of the flat panel display device of FIG. 9 may be substantially similar to the advantages of the flat panel display of FIG. 1 described previously, and therefore, will not be repeated.

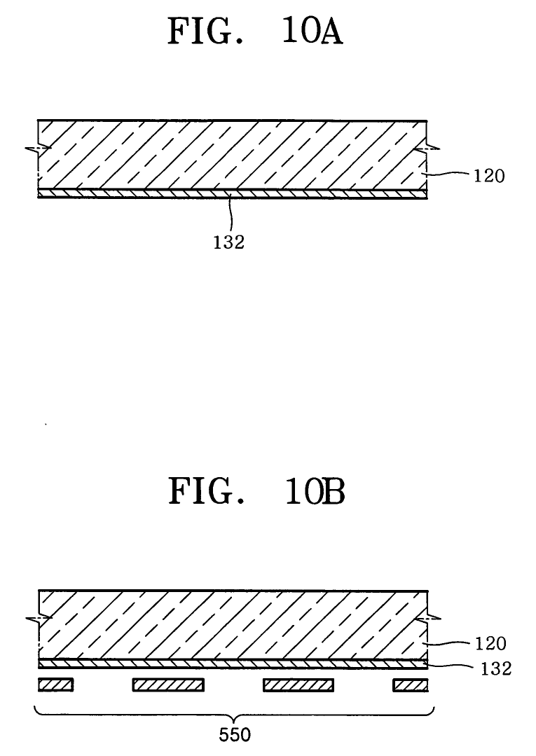

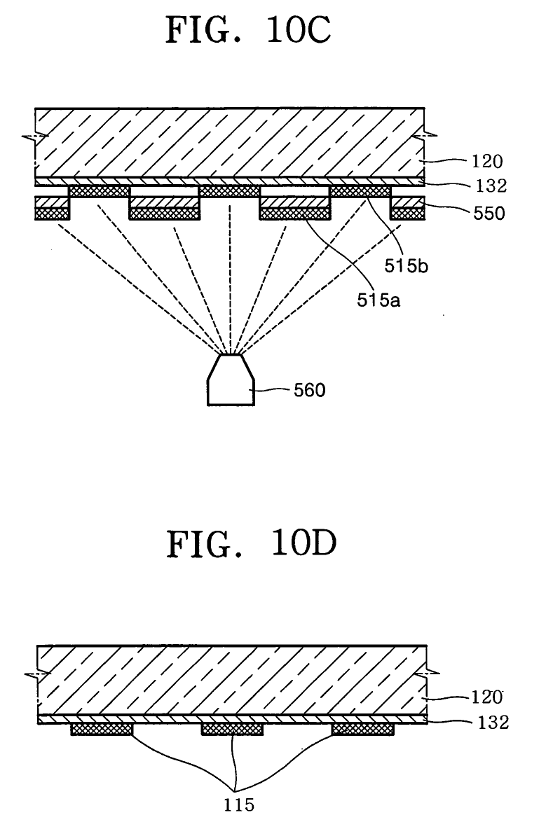

A method of fabricating a photoluminescent layer according to an embodiment of the present invention will be described with reference to FIGS. 10A-10D. Referring to FIG. 10A, the second electrode 132 may be formed on the second substrate 120. Referring to FIG. 10B, a shadow mask 550 having a predetermined pattern, i.e., a pattern corresponding to a pattern of the photoluminescence layer 11 5, may be aligned with the second electrode 132. Alignment of the shadow mask 550 with the second substrate 120 may refer to defining portions of the second electrode 132 to be coated with photoluminescent segments of the photoluminescent layer 115.

Referring to FIG. 10C, a photoluminescent material may be sprayed on the second electrode through the shadow mask 550. In particular, a coating apparatus 560 may be positioned to face the shadow mask, and may spray the photoluminescent material by a chemical vapor deposition (CVD) method, a plasma enhanced chemical vapor deposition (PECVD) method, a sputtering method, a spin coating method, a molecular beam epitaxy (MBE) method, a modified organometallic chemical vapor deposition (MOCVD) method, a printing method, and so forth. As a result, the photoluminescent material may be coated on surfaces of the shadow mask 550, i.e., first portions 515a, and on exposed portions of the second electrode 132, i.e., second portions 515b. The second portions 515b may be the photoluminescent segments of the photoluminescent layer 115. Referring to FIG. 10D, the shadow mask 550 may be removed to expose the photoluminescent layer 115.

Formation of the photoluminescent layer 115 via the shadow mask 550 may be advantageous in facilitating formation of the photoluminescent layer 115 in any suitable pattern. Accordingly, the photoluminescent layer 115 may have a non-continuous pattern, e.g., discrete separate segments. Also, since a method of spraying may include a CVD method, a PECVD method, a sputtering method, a MBE method, a MOCVD method, a spin coating method, and/or a printing method, the photoluminescent material may be easily applied to the second electrode 132 via the shadow mask 550. The method of forming the photoluminescent layer 115 may be used to form any of the flat panel display devices described previously with reference to FIGS. 1-9.

As described above, a flat panel display device according to the embodiments of the present invention may be advantageous in preventing or substantially minimizing charge on a surface of a photoluminescent layer, thereby increasing brightness and transmittance of visible light therethrough. It is noted that examples of a flat panel display device according to embodiments of the present invention may include a plasma display device, e.g., facing discharge type plasma display panel (PDP), surface discharge type PDP, and so forth, an electron emission device, a gas excitation emitting device, and so forth.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A flat panel display device, comprising:
first and second substrates spaced apart and facing each other;
a plurality of discharge cells between the first and second substrates;
an excitation gas in the discharge cells;
a plurality of first electrodes between the first and second substrates;
a plurality of second electrodes between the first and second substrates;
a third electrode on each of the plurality of first electrodes; and
a photoluminescent layer in at least one discharge cell of the plurality of discharge cells, the photoluminescent layer including at least one opening therethrough.

2. The flat panel display device as claimed in claim 1, further comprising a first electron accelerating layer between a first electrode and a respective third electrode, the first electron accelerating layer being adapted to emit a first electron beam into the discharge cells when voltages are applied to the first and third electrodes.

3. The flat panel display device as claimed in claim 2, wherein an energy of the first electron beam is higher than energy required to excite the excitation gas and lower than energy required to ionize the excitation gas.

4. The flat panel display device as claimed in claim 2, wherein the first and second electrodes are a cathode electrode and an anode electrode, respectively.

5. The flat panel display device as claimed in claim 2, wherein the first electron acceleration layer includes oxidized porous silicon.

6. The flat panel display device as claimed in claim 1, wherein the photoluminescent layer includes a plurality of discrete segments.

7. The flat panel display device as claimed in claim 6, wherein the discrete segments have a matrix pattern.

8. The flat panel display device as claimed in claim 6, wherein the discrete segments are spaced apart to have openings therebetween.

9. The flat panel display device as claimed in claim 8, wherein each segment is square-shaped.

10. The flat panel display device as claimed in claim 1, wherein the photoluminescent layer is on one or more of the first substrate, the second substrate, and/or sidewalls of the discharge cell.

11. The flat panel display device as claimed in claim 1, wherein the surface of the discharge cell of the plurality of the discharge cells is a surface of the second electrode.

12. The flat panel display device as claimed in claim 11, wherein the first and second electrodes are on the first and second substrates, respectively, and the photoluminescent layer is on the second electrode, the at least one opening through the photoluminescent layer exposing portions of the second electrode.

13. The flat panel display device as claimed in claim 1, wherein the second and third electrodes have a mesh structure.

14. The flat panel display device as claimed in claim 1, further comprising:
a fourth electrode on each of the plurality of second electrodes;
a second electron accelerating layer between a second electrode and a respective fourth electrode, the second electron acceleration layer being adapted to emit a second electron into the discharge cells when voltages are applied to the second and fourth electrodes; and
a first electron accelerating layer between a first electrode and a respective third electrode, the first electron accelerating layer being adapted to emit a first electron beam into the discharge cells when voltages are applied to the first and third electrodes.

15. The flat panel display device as claimed in claim 14, further comprising:
barrier ribs between the first and second substrates;
a plurality of address electrodes extending on the first substrate along a direction crossing the second and fourth electrodes; and
a dielectric layer on the first substrate, the address electrodes being between the dielectric layer and the first substrate.

16. The flat panel display device as claimed in claim 14, wherein the first and second electrodes are on the first and second substrates, respectively.

17. The flat panel display device as claimed in claim 14, wherein both the first and second electrodes are on the first substrate.

18. The flat panel display device as claimed in claim 17, wherein the photoluminescent layer is directly on the second substrate.

19. The flat panel display device as claimed in claim 14, wherein the first, second, third, and fourth electrodes are perpendicular to planes of the first and second substrates.

20. The flat panel display device as claimed in claim 19, wherein each of the first and second electrodes is in contact with both the first and second substrates.
